(19) United States
(12) Patent Application Publication
(10) Pub. No.: US 2024/0430606 A1
(43) Pub. Date: Dec. 26, 2024

(54) Ear-Hanging Headphone

(71) Applicant: Yuanhao Liu, Shenzhen (CN)

(72) Inventor: Yuanhao Liu, Shenzhen (CN)

(21) Appl. No.: 18/241,897

(22) Filed: Sep. 4, 2023

(30) Foreign Application Priority Data
Jun. 20, 2023 (CN) 202310735107X

(51) Int. Cl. H04R 1/10

(52) U.S. Cl. CPC H04R 1/105; H04R 1/1016; H04R 1/1041; H04R 2460/01

(57) ABSTRACT

An ear-hanging headphone includes a cavum conchae wearing portion for being placed in a user's cavum conchae and biasing against the user's antitragus, an ear-hanging fixing assembly for fitting against a back side of the user's ear root, and a connecting assembly, wherein two ends of the connecting assembly are respectively connected to the cavum conchae wearing portion and the ear-hanging fixing assembly to form a fixing area for holding the user's earlobe.

### CROSS REFERENCE OF RELATED APPLICATION

This application is a non-provisional application that claims priority under 35 U.S.C. § 119 to China application number CN202310735107.X, filing date Jun. 20, 2023, wherein the entire content of which is expressly incorporated herein by reference.

### BACKGROUND OF THE PRESENT INVENTION

### Field of Invention

The present invention relates to the field of headphones, and more particularly to an ear-hanging headphone.

### Description of Related Arts

An earphone, which is a commonly used electronic product in our daily lives, receives electrical signals emitted by a media player or a receiver and converts the signals into audible sound waves by a speaker that are close to the ears. The earphone allows individuals to listen to audio without disturbing others and are also helpful for isolating surrounding noises in environments such as recording studios, bars, travel, and sports.

Since the first iron-moving head-wearing headphones in 1910 is developed, headphones have become indispensable accessories nowadays, the development of headphones has a history of over a hundred years. Currently, there are various types of headphones available on the market, including headset earphones, in-ear headphones, and earplug headphones, etc. Each type of headphones has different disadvantages and cannot meet the different needs of users.

Although headset headphones have better sound quality and noise isolation, and their design is more stylish, due to their large size and heavy weight, long-term wearing can easily compress the auricle and the top of the head, and thus may cause hearing disorder of the user. In some special situations, not being able to hear external environment noise can easily lead to accidents, and their large sizes make them difficult to store. When the weather is hot, the sweating of user can easily damage the headset earphones.

In-ear headphones and earbud headphones usually need to be inserted into the user's ear canal, which can be tiring and also may cause certain hearing disorder and damage, the comfort level is poor. In addition, long-term wearing can easily breed bacteria and be unhygienic. When users are participating in vigorous exercises, it is easy for the headphones to fall off. Similarly, in some situations, if they cannot hear external environment noise, it can easily lead to accidents. In addition, the conventional headphone styles are relatively monotonous, with poor overall aesthetics and lack of personalization. Moreover, when users wear pairs of glasses or other items, the wearing portions of some open-ear headphones are easily interfered with the temples of the glasses, so that they are not convenient to use.

### SUMMARY OF THE PRESENT INVENTION

The invention is advantageous in that it provides an ear-hanging headphone, wherein a cavum conchae wearing portion of the ear-hanging headphone is suitable for being placed in the user's cavum conchae without blocking and sealing off the ear canal, thus avoiding the feeling of pressure in the ear canal, and without damaging the eardrum and causing hearing loss.

Another advantage of the present invention is that it provides an ear-hanging headphone, wherein after wearing and adjusting the size properly, the cavum conchae wearing portion of the ear-hanging headphone is placed at the cavum conchae, and an outer side of the ear-hanging fixing assembly fits against a back side of the user's ear root, thereby improving the wearing stability of the ear-hanging headphone, making it not easy to fall off, and allowing for long-term wearing.

Another advantage of the present invention is that it provides an ear-hanging headphone, wherein the cavum conchae wearing portion of the ear-hanging headphone is placed at the cavum conchae, which does not affect the listening effect and does not leak sound, people nearby cannot hear the sound transmitted by the ear-hanging headphone, so that it does not affect others and ensures privacy, thus enhancing the privacy of the ear-hanging headphone.

Another advantage of the present invention is that it provides an ear-hanging headphone, wherein the cavum conchae wearing portion of the ear-hanging headphone is only equipped with the speaker, which allows for a larger speaker size and thus improves the sound quality of the ear-hanging headphone.

Another advantage of the present invention is that it provides an ear-hanging headphone, wherein the ear-hanging headphone comprises a smart communication module which allows for interaction with the user, such as providing feedback on searched network information, online shopping, audio playback, making phone calls, sending emails, controlling home or office devices, and improving convenience in daily life.

Another advantage of the present invention is that it provides an ear-hanging headphone, wherein the ear-hanging headphone comprises a decorative unit which can enhance the aesthetics of the ear-hanging headphone through processes such as diamond inlaying diamond, pattern forming, or carving.

Another advantage of the present invention is that it provides an ear-hanging headphone, wherein the ear-hanging headphone is made of copper material, which facilitates the installation of the decorative unit. Additionally, other materials such as silver, stainless steel, precious metals like pure gold or K gold, as well as ABS, PP, PC, rubber, silicone, and other materials can also be used. These materials can be elastic or rigid, so as to achieve diversity in the ear-hanging headphone.

Another advantage of the present invention is that it provides an ear-hanging headphone, wherein the ear-hanging headphone can be equipped with other smart sensors, such as an optical heart rate sensor, so as to measure the user's heart rate, thereby modifying the depressed mood of the user by adjusting the user's emotion state to make the mood pleasant.

Another advantage of the present invention is that it provides an ear-hanging headphone, wherein the ear-hanging headphone comprises a hearing aid module, so as to combining the ear-hanging headphone with a hearing-aid, so that the ear-hanging headphone is capable of making and receiving phone calls wile being able to hear the speaking of others, and realizing free switching between the functions of headphone and hearing-aid, avoiding the trouble caused by replacing the headphone or the hearing-aid device in different occasions.

Another advantage of the present invention is that it provides an ear-hanging headphone, wherein the ear-hanging headphone have a long battery life, low power consumption of the control circuit board, and a power amplifier may not be required, thus reducing power consumption and greatly improving the single-use duration of the ear-hanging headphone, so so to reduce the user's power anxiety.

Another advantage of the present invention is that it provides an ear-hanging headphone, wherein the quality of the ear-hanging headphone can be controlled without pressure of heaviness, so as to solve the discomfort caused by the weight of the headphones for the user.

Another advantage of the present invention is that it provides an ear-hanging headphone, wherein the ear-hanging headphone can be manufactured and assembled by a plurality of sections or by two half parts, so as to minimize the material waste and improve the production efficiency to the greatest extent.

Another advantage of the present invention is that it provides an ear-hanging headphone, wherein a connecting assembly of the ear-hanging headphone has a connecting groove, and the wires of the ear-hanging headphone is suitable for being installed in the connecting groove, so that the user can choose the color and style according to their own preferences, which improves the aesthetics of the ear-hanging headphone.

Additional advantages and features of the invention will become apparent from the description which follows, and may be realized by means of the instrumentalities and combinations particularly pointing out in the appended claims.

According to an aspect of the present invention, the present invention provides an ear-hanging headphone comprising a cavum conchae wearing portion for being placed in a user's cavum conchae and biasing against the user's antitragus, an ear-hanging fixing assembly for fitting against a back side of the user's ear root, and a connecting assembly, wherein two ends of the connecting assembly are respectively connected to the cavum conchae wearing portion and the ear-hanging fixing assembly to form a fixing area for holding the user's earlobe.

According to an embodiment of the present invention, the cavum conchae wearing portion comprises a main body portion, a cover portion, and a speaker, wherein the cover portion is mounted on the main body portion, and the speaker is enclosed by the main body portion and the cover portion.

According to an embodiment of the present invention, the cover portion has a plurality of holes penetrating the cover portion.

According to an embodiment of the present invention, the ear-hanging fixing assembly comprises a fixing portion, an outer shell, and an inner shell, wherein the outer shell and the inner shell are respectively mounted two sides of the fixing portion to define an installation space.

According to an embodiment of the present invention, the ear-hanging headphone further comprises a control assembly comprising a headphone power supply and a control circuit board, wherein the headphone power supply and the control circuit board are both disposed in the ear-hanging fixing assembly.

According to an embodiment of the present invention, the ear-hanging headphone further comprises a smart communication module which is disposed in the ear-hanging fixing assembly, wherein the smart communication module is electrically connected to the control circuit board.

According to an embodiment of the present invention, the connecting assembly comprises a first connecting portion, wherein two ends of the first connecting portion are respectively connected to the cavum conchae wearing portion and the ear-hanging fixing assembly.

According to an embodiment of the present invention, the ear-hanging headphone further comprises a second connecting portion which is spacedly apart from the first connecting portion, wherein a lower end of the second connecting portion is mounted to the ear-hanging fixing assembly.

According to an embodiment of the present invention, the first connecting portion comprises an extending element, an upper extension portion, and a lower extension portion, wherein the upper extension portion and the lower extension portion are respectively integrally connected to an upper end and an lower end of the extending element, respectively, so as to be connected the cavum conchae wearing portion and the ear-hanging fixing assembly.

According to an embodiment of the present invention, the connecting assembly comprises a first connecting portion and a second connecting portion, wherein the first connecting portion and the second connecting portion are interconnected to form an integral structure.

According to an embodiment of the present invention, the first connecting portion comprises an upper fixing portion and an upper bending portion, and the second connecting portion comprises a lower fixing portion and a lower bending portion, wherein the upper fixing portion is connected to the cavum conchae wearing portion, the upper bending portion and the lower bending portion are interconnected, and the lower fixing portion is connected to the ear-hanging fixing assembly.

According to an embodiment of the present invention, the ear-hanging headphone further comprises a decorative unit, which is provided on at least a portion of the cavum conchae wearing portion, the ear-hanging fixing assembly, and the connecting assembly.

According to an embodiment of the present invention, the connecting assembly comprises wires and has a connecting groove indented along one of outer side and inner side of the connecting assembly, wherein the wires are disposed in the connecting groove.

According to an embodiment of the present invention, the control assembly further comprises a hearing aid module which is provided in the ear-hanging fixing assembly, wherein the hearing aid module is electrically connected to the control circuit board.

According to an embodiment of the present invention, when the ear-hanging headphone is worn on the user, a lower portion of the cavum conchae wearing portion is biasing against the user's antitragus, wherein the ear-hanging fixing assembly fits against the back side of the user's earlobe, wherein an inner side edge of the ear-hanging fixing assembly is biasing against the back side of the user's ear root for positioning the ear-hanging headphone.

According to an embodiment of the present invention, when the ear-hanging headphone is worn on the user, the connecting assembly is inclinedly extended between the cavum conchae wearing portion and the ear-hanging fixing assembly.

According to an embodiment of the present invention, a material of the main body portion of the cavum conchae wearing portion, the ear-hanging fixing assembly, and the connecting assembly is one of copper, silver, stainless steel, precious metal, ABS material, PP material, PC material, rubber, and silicone material.

Still further objects and advantages will become apparent from a consideration of the ensuing description and drawings.

### BRIEF DESCRIPTION OF THE DRAWINGS

FIG. 1 is a perspective view illustrating an overall structure of an ear-hanging headphone according to a first preferred embodiment of the present invention.

FIG. 2 is another perspective view illustrating the overall structure of the ear-hanging headphone according to the above first preferred embodiment of the present invention.

FIG. 3 is an exploded view of an ear-hanging headphone according to the above first preferred embodiment of the present invention.

FIG. 4 is a perspective view illustrating the ear-hanging headphone being worn on a user's ear according to the above first preferred embodiment of the present invention.

FIG. 5 is a schematic view illustrating an application scenario of the ear-hanging headphone according to the above first preferred embodiment of the present invention.

FIG. 6 is a perspective view illustrating a pattern of a decorative unit of the ear-hanging headphone according to the above first preferred embodiment of the present invention.

FIG. 7 is a perspective view illustrating another pattern of the decorative unit of the ear-hanging headphone according to the above first preferred embodiment of the present invention.

FIG. 8 is a perspective view illustrating an overall structure of an ear-hanging headphone according to a second preferred embodiment of the present invention.

FIG. 9 is another perspective view illustrating the overall structure of the ear-hanging headphone according to the above second preferred embodiment of the present invention.

FIG. 10 is a perspective view illustrating an arrangement of a decorative unit of an ear-hanging headphone according to the above second preferred embodiment of the present invention.

FIG. 11 is a perspective view illustrating an overall structure of an ear-hanging headphone according to a third preferred embodiment of the present invention.

FIG. 12 is a perspective view illustrating an overall structure of an ear-hanging headphone according to a fourth preferred embodiment of the present invention

FIG. 13 is a schematic view illustrating a control assembly of the ear-hanging headphone according to the above fourth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confined to the present invention.

It should be understood that the term “a” or “an” should be understood as “at least one” or “one or more”, that is, in one embodiment, the quantity of a component can be one, while in another embodiment, the quantity of the component can be more than one. The term “a” or “an” should not be understood as limiting the quantity.

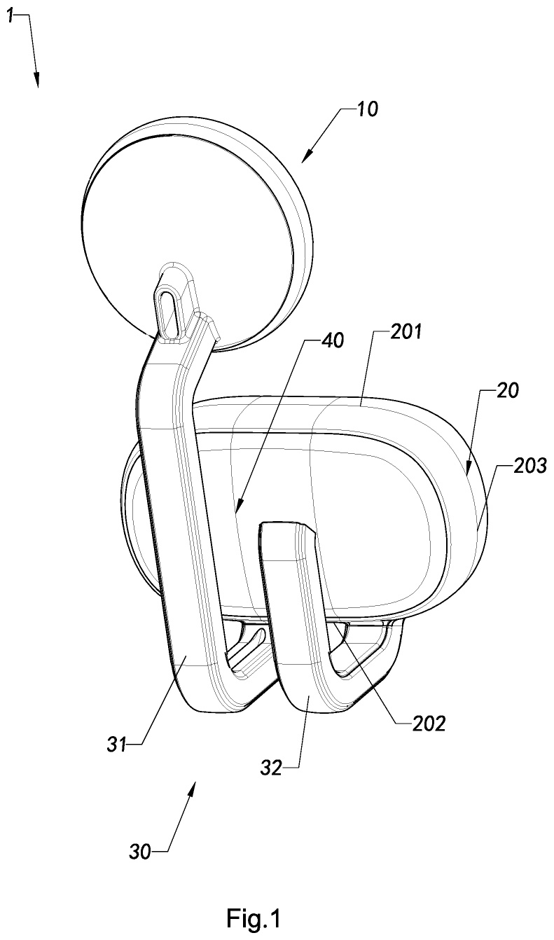

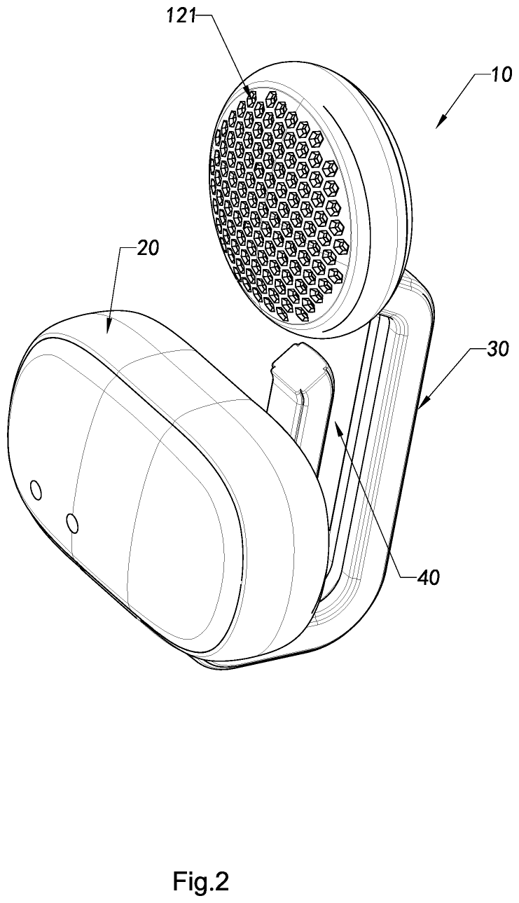

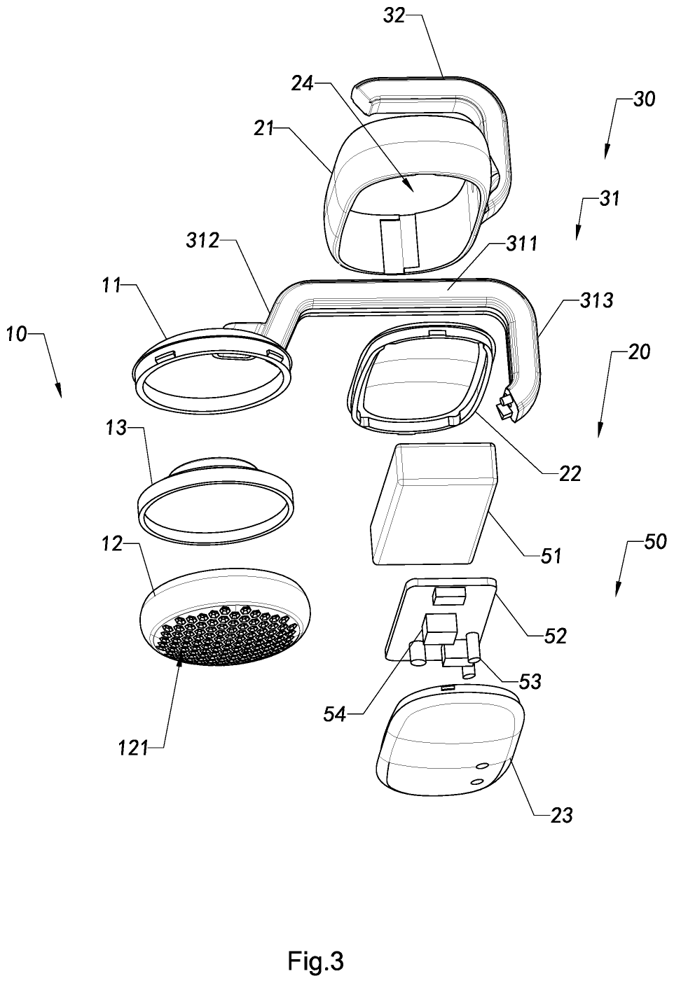

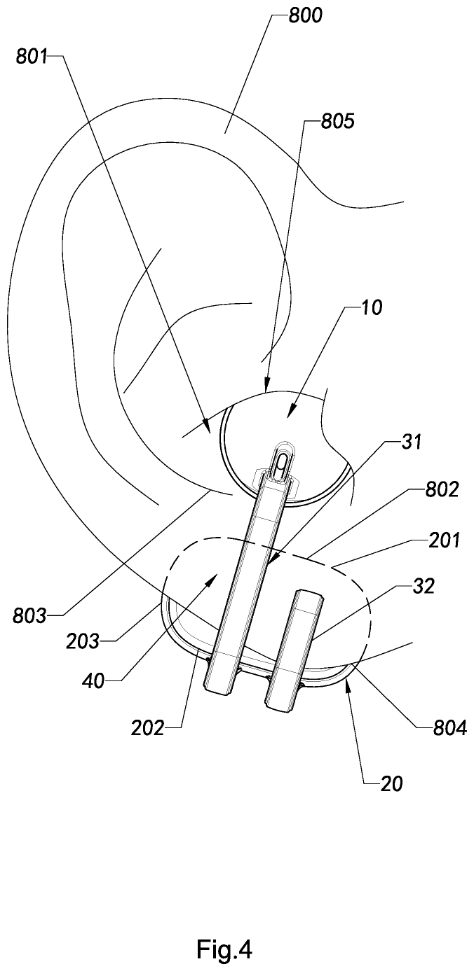

Referring to FIGS. 1 to 7 of the drawings, an ear-hanging headphone 1 according to a first preferred embodiment of the present invention is illustrated. The ear-hanging headphone 1 receives telecommunication signals emitted from a media player or a receiver and convert the signals into audible sound waves by a speaker close to a user's ear 800. The ear-hanging headphone 1 is suitable for being retained at a cavum conchae 801 of the user's ear 800 without closing and sealing off an ear canal 805, thus avoiding any feeling of pressure on the ear canal 805 and preventing damage to the eardrum which could lead to hearing loss or hearing disorder.

For the purpose of illustration, in this embodiment, an end portion of the ear-hanging headphone 1 which is adapted for being placed at the cavum conchae 801 is defined as a front end portion of the ear-hanging headphone 1, and the other end portion which is opposite to the front end portion of the ear-hanging headphone 1 is regarded as a back end portion of the ear-hanging headphone 1. A side of the ear-hanging headphone 1 which is adjacent to the cavum conchae 801 is denoted as an inner side of the ear-hanging headphone 1, and a side of the ear-hanging headphone 1 which is away from the cavum conchae 801 is regarded as an outer side of the ear-hanging headphone 1.

FIG. 1 is a perspective view illustrating an overall structure of the ear-hanging headphone 1 according to the first preferred embodiment of the present invention. In this embodiment, the ear-hanging headphone 1 comprise a cavum conchae wearing portion 10, an ear-hanging fixing assembly 20, and a connecting assembly 30. A front end of the connecting assembly 30 is connected to the cavum conchae wearing portion 10, and the rear end of the connecting assembly 30 is connected to the ear-hanging fixing assembly 20. The cavum conchae wearing portion 10 and the ear-hanging fixing assembly 20 are not in the same vertical plane.

That is to say, the two ends of the connecting assembly 30 are respectively connected to the cavum conchae wearing portion 10 and the ear-hanging fixing assembly 20. The cavum conchae wearing portion 10 is suitable for being placed in the user's cavum conchae 801, and the inner side of the cavum conchae wearing portion 10 is facing towards the user's ear canal 805. The ear-hanging fixing assembly 20 is suitable for fitting on an inner side of the user's earlobe 804.

The ear-hanging headphone 1 has a fixing area 40, which is define between the cavum conchae wearing portion 10 and the ear-hanging fixing assembly 20, and is surrounded and restricted by the connecting assembly 30. The user's earlobe 804 is suitable to be clamped within the fixing area 40 located between the cavum conchae wearing portion 10 and the ear-hanging fixing assembly 20, and attached to the connecting assembly 30 for fixation. This improves the wearing stability of the ear-hanging headphone 1, making the ear-hanging headphone 1 less likely to fall off even during vigorous movements, and can be worn for a long time.

The cavum conchae wearing portion 10 comprises a main body portion 11, a cover portion 12, and a speaker 13. The cover portion 12 is detachably installed on the main body portion 11, and the speaker 13 is disposed between the main body portion 11 and the cover portion 12 and enclosed by the main body portion 11 and the cover portion 12. The speaker 13 is capable of converting the electrical signals emitted from the media player or the receiver into audible sound waves.

A sealed chamber is not formed between the cavum conchae wearing portion 10 and the wearer's eardrum, so that the ear-hanging headphone 1 are open headphones that do not cause impact damage to the eardrum and can maintain good sound quality.

The cover portion 12 has multiple holes 121 extending and penetrating the cover portion 12. The holes 121 allow air in the speaker 13 to enter the wearer's ear canal 805 to balance the air pressure in the speaker 13, so that the sound can be better transmitted to the wearer's ear canal 805. After the ear-hanging headphone 1 are worn by the wearer, the cavum conchae wearing portion 10 is placed in the wearer's cavum conchae 801 without entering the deep position in the ear canal 805, and the inner side of the cavum conchae wearing portion 10 faces the wearer's ear canal 805. That is to say, the cover portion 12 of the cavum conchae wearing portion 10 faces the wearer's ear canal 805, so that the sound emitted by the speaker 13 can be better transmitted to the wearer's ear canal 805.

It is worth mentioning that in conventional headphones, the speaker, battery, and circuit board are integrated and disposed into a same space. Therefore, the occupied space of the speaker will be relatively reduced, and thus the size of the speaker will be relatively reduced. In the present invention, the ear-hanging headphone 1 only arranges the speaker 13 in the cavum conchae wearing portion 10, which can make the overall size of the speaker 13 larger, thereby improving the sound quality effect of the ear-hanging headphone 1.

The cavum conchae wearing portion 10 of the ear-hanging headphone 1 is placed in the cavum conchae 801, which does not affect the listening effect, nor does it leaks sound. People nearby will not hear the sound transmitted by the ear-hanging headphone 1, which does not affect others and also ensures privacy and prevents eavesdropping, thereby improving the privacy of the ear-hanging headphone 1.

The ear-hanging fixing assembly 20 comprises a fixing portion 21, an outer shell 22, an inner shell 23, and defines an installation space 24. The outer shell 22 and the inner shell 23 are detachably installed on the outer and inner sides of the fixing portion 21, and the installation space 24 is defined inside the fixing portion 21, and the installation space 24 is surrounded by the fixing portion 21, the outer shell 22, and the inner shell 23 to form a sealed space area.

It is worth mentioning that, after the ear-hanging headphone 1 is worn by the user, the lower portion of the cavum conchae wearing portion 10 abuts against the user's antitragus 803, and the outer shell 22 of the ear-hanging fixing assembly 20 abuts against a back side of the user's ear root 802. The cavum conchae wearing portion 10, the ear-hanging fixing assembly 20 and the connecting assembly 30 form a lever structure, causing the cavum conchae wearing portion 10 tend to to float at the user's cavum conchae 801, reducing discomfort and avoiding harm to the user.

The ear-hanging fixing assembly 20 comprises an inner side edge 201, an outer side edge 202, and two end side edges 203. In this embodiment, after the ear-hanging headphone 1 are worn by the user, the inner side edge 201 of the outer shell 22 of the ear-hanging fixing assembly 20 biases against the back side of the user's ear root 802 for positioning and retaining the ear-hanging headphone 1.

The ear-hanging headphone 1 further comprise a control assembly 50 which is installed inside the ear-hanging fixing assembly 20. Furthermore, the control assembly 50 is positioned within the installation space 24 of the ear-hanging fixing assembly 20.

The connecting assembly 30 comprises a first connecting portion 31 and a second connecting portion 32. The two ends of the first connecting portion 31 are respectively connected to the cavum conchae wearing portion 10 and the ear-hanging fixing assembly 20. The lower end of the second connecting portion 32 is connected to the ear-hanging fixing assembly 20. In other words, the length of the first connecting portion 31 is greater than the length of the second connecting portion 32, and the lower structural form of the first connecting portion 31 is the same as that of the second connecting portion 32. In this embodiment, the first connecting portion 31 and the second connecting portion 32 are connected in parallel between the cavum conchae wearing portion 10 and the ear-hanging fixing assembly 20. In other feasible embodiments, the first connecting portion 31 and the second connecting portion 32 can also be set in other ways between the cavum conchae wearing portion 10 and the ear-hanging fixing assembly 20. This is not a limitation of the present invention.

Furthermore, the first connecting portion 31 comprises an extending element 311, an upper extension portion 312, and a lower extension portion 313, wherein the upper extension portion 312 and the lower extension portion 313 are respectively integrally connected to the upper end and lower end of the extending element 311. In other words, the extending element 311 is connected to the main body portion 11 of the cavum conchae wearing portion 10 through the upper extension portion 312, and the extending element 311 is connected to the fixing portion 21 of the ear-hanging fixing assembly 20 through the lower extension portion 313.

Specifically, the upper extension portion 312 and the lower extension portion 313 are respectively extended and bent from the extending portion 311 at a predetermined angle. Among them, the upper extension portion 312 is extending at an angle of 30° to 45° and is connected to the cavum conchae wearing portion 10, and the lower extension portion 313 is extending at an angle of 90° and is connected to the lower end of the ear-hanging fixing assembly 20. The first connecting portion 31 and the second connecting portion 32 together form a hook shape, and the center of gravity of the cavum conchae wearing portion and the center of gravity of the ear-hanging fixing assembly 20 is set at approximately 45° to conform to the structure of the human ear, so that the ear-hanging headphone 1 can be stably fixed to the patient's ear without causing discomfort. Accordingly, when the ear-hanging headphone 1 is worn on the user's ear 800, the extending element 313 defines an include angle of about 45° with respect to the horizontal plane.

More specifically, when the ear-hanging headphone 1 are worn on the user's ear, the cavum conchae wearing portion 10 is placed inside the cavum conchae 801, the ear-hanging fixing assembly 20 is fitted an a back side of the user's earlobe 804, the first connecting portion 31 is fitted on the outside of the user's earlobe 804, and the second connecting portion 32 is also fitted on the outside of the user's earlobe 804 with its end placed on the earlobe 804. This configuration positions the user's earlobe 804 within the fixing area 40, so as to complete the wearing of the ear-hanging headphone 1. The added second connecting portion 32 is used to fit on the earlobe 804 for more stable positioning of the ear-hanging headphone 1.

Among them, in this embodiment, the extending element 311 is integrally connected and fixed to the cavum conchae wearing portion 10 through the upper extension portion 312, and the extending element 311 may be detachably connected to the ear-hanging fixing assembly 20 through the lower extension portion 313. In other embodiments, the first connecting portion 31 can be integrally connected between the cavum conchae wearing portion 10 and the ear-hanging fixing assembly 20, or can be detachably connected between the cavum conchae wearing portion 10 and the ear-hanging fixing assembly 20. The cavum conchae wearing portion 10 and the ear-hanging fixing assembly 20 can also be assembled from left and right parts, and this is not a limitation of the present invention. The ear-hanging headphone 1 can be manufactured and installed by using multi-segment assembly or two-half combination, which minimizes material waste and improves production efficiency.

The control assembly 50 comprises a headphone power supply 51, a control circuit board 52, and at least one adjustment button 53. The headphone power supply 51 and the control circuit board 52 are both disposed in the installation space 24 of the ear-hanging fixing assembly 20. The adjustment button 53 is set on the surface of the inner shell 23 of the ear-hanging fixing assembly 20, which is convenient for the user to touch and press. It can be understood that in other modified embodiments, one of the headphone power supply 51 and the control circuit board 52 can also be received in the cavum conchae wearing portion 10.

The headphone power supply 51, the control circuit board 52, and the adjustment button 53 are electrically connected to each other. During use, the user can adjust the volume, switch channels, and turn the power on and off by touching and pressing the adjustment button 53 with his or her finger. Specifically, different adjustments can be achieved by controlling the pressing time and number of presses of the adjustment button 53. By pressing the adjustment button 53, the user transmits a signal to the control circuit board 52 to achieve different functional adjustments.

The control assembly 50 further comprises a smart communication module 54 which is incorporated into the ear-hanging fixing assembly 1. The smart communication module 54 can transmit signals to, for example, a smart home appliance to complete the automatic operation of the smart home appliance. Based on this, the ear-hanging headphone 1 can interact with the user, such as providing feedback on network information, conducting online shopping, playing audio, making phone calls, sending emails, controlling home or office devices, and improving the convenience of life.

Specifically, the smart communication module 54 is an artificial intelligent module on the circuit board which is equipped with a wireless communication module and a microphone for voice collection. The artificial intelligent module can interact with the user. Based on this, the smart communication module 54 of the ear-hanging headphone 1 can also be equipped with a microphone device to receive user's voice commands, so that the ear-hanging headphone 1 can serve as a terminal device for smart voice interaction. The microphone device is electrically connected to the smart communication module 54.

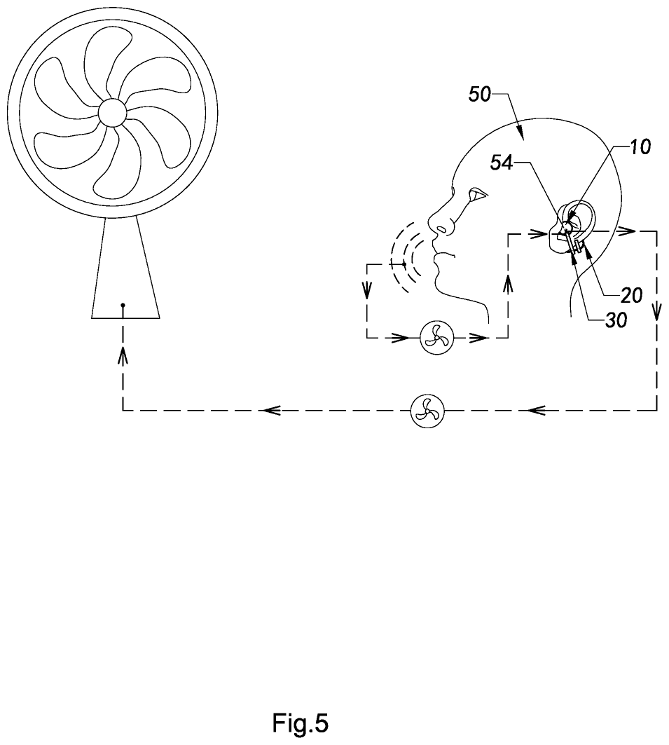

FIG. 5 illustrates an application scenario of an ear-hanging headphone according to the first preferred embodiment of the present invention. For example, in the morning, the user of the ear-hanging headphone 1 sends a command “open the window” to the ear-hanging headphone 1. “Open the window” voice command, after the smart communication module 54 of the ear-hanging headphone 1 receives the command output by the user, it transmits the command to the window's sensing system to “open the window”. Upon receiving the signal transmitted by the smart communication module 54, the window automatically opens in response to the instruction “open the window”. At night, the user of the ear-hanging headphone 1 sends a “turn off the fan” voice command to the ear-hanging headphone 1, after the smart communication module 54 of the ear-hanging headphone 1 receives the command output by the user, it transmits the command to the sensing system of the fan to turn off the fan, the fan automatically turns off after receiving the signal transmitted by the smart communication module 54.

It can be understood that the voice interaction here is only used as an example, the ear-hanging headphone 1 of the ear-hanging fixing assembly. It can also be widely applied to various intelligent interactive scenarios in smart home control, smart office, smart communication, smart driving, smart healthcare, etc.

It is worth mentioning that the microphone device can be built-in with algorithms to have noise reduction effect, that is, when receiving the user's voice commands, the microphone device can reduce the noise in the environment, so that the microphone device can obtain a purer user's voice. The ear-hanging headphone 1 are equipped with the smart communication module 54, which can be used in conjunction with smart home, smart calling, smart driving, etc., so as to improve the convenience of user's life.

It is worth mentioning that the ear-hanging headphone 1 can be equipped with other smart sensors, such as an optical heart rate sensor, which can be located in the ear-hanging fixing assembly 20 and provided at the position of the user's earlobe 804, the light reflected back through the skin tissue is received by the photosensitive sensor and converted into an electrical signal, and then converted into a digital signal through AD conversion, so as to measure the user's heart rate.

The ear-hanging headphone 1 also have the function of improving the user's mood. For example, when the user is under a lot of study or work pressure, the ear-hanging headphone 1 can monitor the user's heart rate and other mood values through light sensing, and then play preset music or imitate sound effects to relieve the user's depressed mood, so as to adjust the state of the user to make the mood pleasant. Parents can also monitor their children's situation through a mobile app to intervene artificially and avoid bad things from happening.

In addition, the ear-hanging headphone 1 can be powered for up to 18-20 hours, and the power consumption of the control circuit board 52 is as low as 5 mA. Since the ear-hanging headphone 1 do not have a power amplifier, the power consumption is small, greatly improving the single-use duration of the ear-hanging headphone 1 and solving the user's power anxiety. Moreover, the ear-hanging headphone 1 have a small size, for example, set to within 16 g, without pressure or a heavy feeling, reducing the discomfort when worn by the user.

The ear-hanging headphone 1 further comprise a decorative unit 60, which is suitable to be configured on at least one surface of the main body portion 11, the ear-hanging fixing assembly 20, and the connecting assembly 30 of the cavum conchae wearing portion 10. The decorative unit 60 can be decorated with diamonds, patterns, carvings, and other processes, or can be detachably connected to enhance the decorative nature of the ear-hanging headphone 1 and improve their aesthetics.

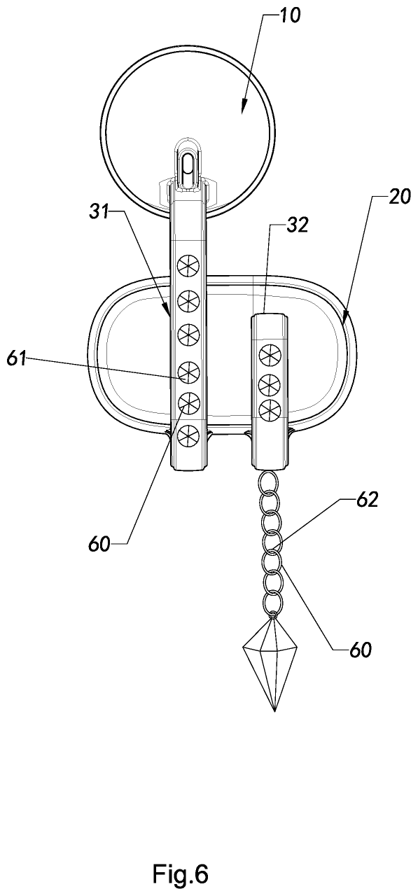

FIG. 6 of the drawings illustrates a pattern of the decorative unit 60 of the ear-hanging headphone according to the first preferred embodiment of the present invention. In this embodiment, the decorative unit 60 comprises a plurality of decorate elements 61 arranged on the surfaces of the first connecting portion 31 and the second connecting portion 32 of the connecting assembly 30. The lower end of the second connecting portion 32 is also suspended with a pendant element 62 of the decorative unit 60. That is to say, point-shaped decorations, such as acrylic, metal, or plastic materials, can be arranged on the surfaces of the first connecting portion 31 and the second connecting portion 32. In this embodiment, the lower end of the second connecting portion 32 is suspended with a diamond decoration.

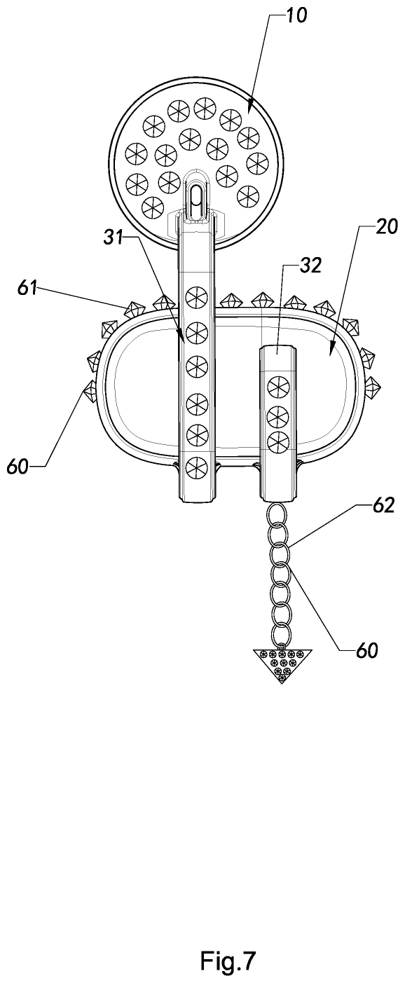

FIG. 7 of the drawings illustrates another pattern of the decorative unit 60 of the ear-hanging headphone according to the first preferred embodiment of the present invention. As shown in the drawings, the decorative unit 60 is arranged on the surfaces of the main body portion 11 of the cavum conchae wearing portion 10 and the ear-hanging fixing assembly 20. The lower end of the connecting assembly 30 is also suspended with a decorative unit 60. Specifically, in this embodiment, the decorative unit 60 suspended at the lower end of the connecting assembly 30 is set to be triangular in shape.

Based on this, the decorative unit 60 can be set as a dot-shaped decoration comprising decorative elements 61 which may be diamonds or jewelries distributed on the surface of the cavum conchae wearing portion 10, the ear-hanging fixing assembly 20, and the connecting assembly 30. In other embodiments, the decorative unit 60 can also be set as a strip-shaped decoration, to be suspended on the connecting assembly 30. In this regard, the shape and style of the decorative unit 60 are not limitations of the present invention. The shape of the decorative unit 60 can be set as triangular, diamond-shaped, spherical, or irregular, and the material can also be selected from materials such as acrylic, metal, or plastic. Users can customize the decorative unit 60 on the ear-hanging headphone 1 according to their own preferences, aesthetics, and value tolerance, so that the ear-hanging headphone 1 is assumed to be a decorative earring when worn on the user's ear 800.

It is worth mentioning that the main body portion 11 of the cavum conchae wearing portion 10 of the ear-hanging headphone 1, the ear-hanging fixing assembly 20, and the connecting assembly 30 of the ear-hanging headphone 1 are preferably made of copper material for convenient installation of the decorative unit 60. Moreover, they have a certain degree of flexibility, allowing for fine adjustment of the size of the fixing area of the ear-hanging headphone 1 to accommodate different users' ear sizes. Additionally, the material of the main body portion 11 of the cavum conchae wearing portion 10, the ear-hanging fixing assembly 20, and the connecting assembly 30 can also be silver, stainless steel, precious metals such as pure gold, or materials such as ABS, PP, PC, rubber, silicone, etc. The material can be elastic or rigid, achieving the diversity of the ear-hanging headphone.

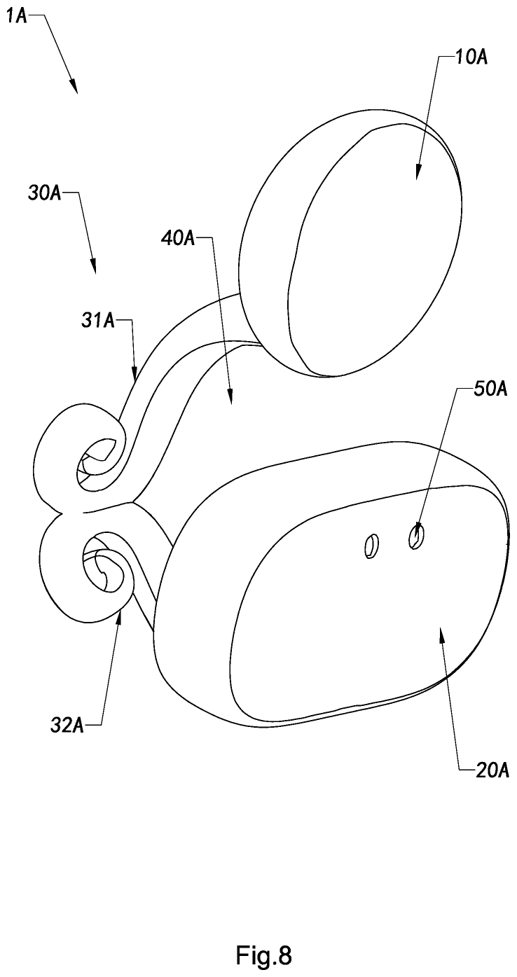

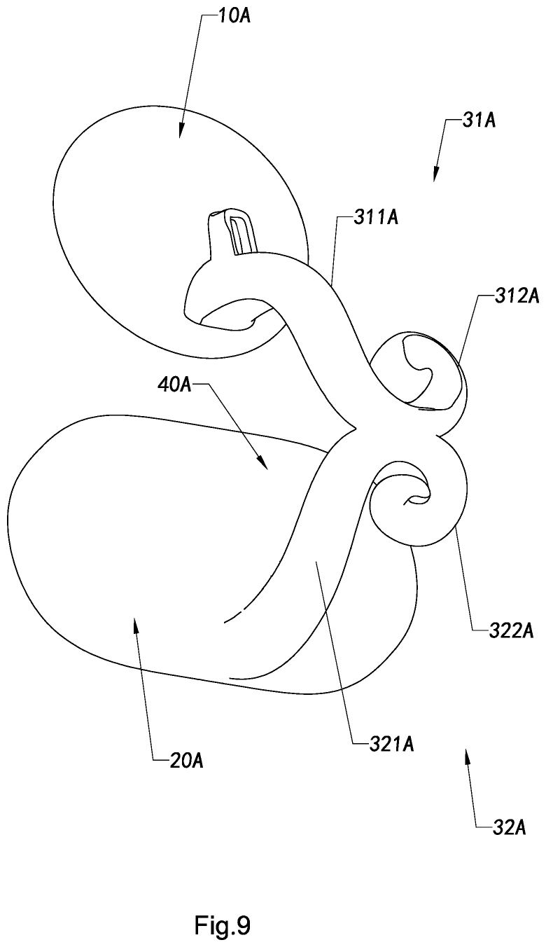

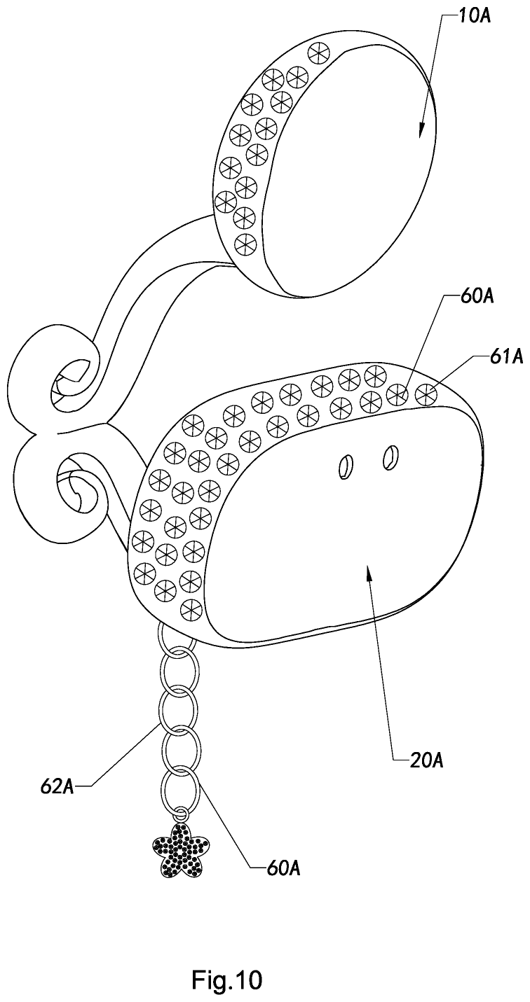

FIGS. 8 to 10 of the drawings illustrate an ear-hanging headphone 1A according to a second preferred embodiment of the present invention. In this preferred embodiment, the connecting assembly 30A has been modified compared to the first preferred embodiment mentioned above.

In this embodiment, the cavum conchae wearing portion 10A, the ear-hanging fixing assembly 20A, the fixing area 40A, and the control assembly 50A are similar to those in the above embodiments, so they will not be described again here. Specifically, FIG. 8 is a perspective view illustrating an overall structure of the ear-hanging headphone 1A according to the second preferred embodiment of the present invention. In this embodiment, the connecting assembly 30A comprises a first connecting portion 31A and a second connecting portion 32A, which are connected to each other and located between the cavum conchae wearing portion 10A and the ear-hanging fixing assembly 20A, and together surround and form the fixing area 40A. Specifically, the upper end of the first connecting portion 31A is connected to the cavum conchae wearing portion 10A, the lower end of the first connecting portion 31A is connected to the upper end of the second connecting portion 32A, and the lower end of the second connecting portion 32A is connected to the ear-hanging fixing assembly 20A.

The first connecting portion 31A comprises an upper fixing portion 311A and an upper bending portion 312A, wherein the upper fixing portion 311A and the upper bending portion 312A are integrally connected. The second connecting portion 32A comprises a lower fixing portion 321A and a lower bending portion 322A, wherein the lower fixing portion 321A and the lower bending portion 322A are integrally connected. Among them, the upper fixing portion 311A is connected to the cavum conchae wearing portion 10A, the upper bending portion 312A is connected to the lower bending portion 322A, and the lower fixing portion 321A is connected to the ear-hanging fixing assembly 20A. The upper bending portion 312A and the lower bending portion 322A are spirally bent, and the upper fixing portion 311A and the lower fixing portion 321A are bent with a predetermined curvature, which increases the aesthetics of the ear-hanging headphone 1A.

Based on this, it should be understood by those skilled in the art that the shape and style of the connecting assembly 30A are not limitations of the present invention.

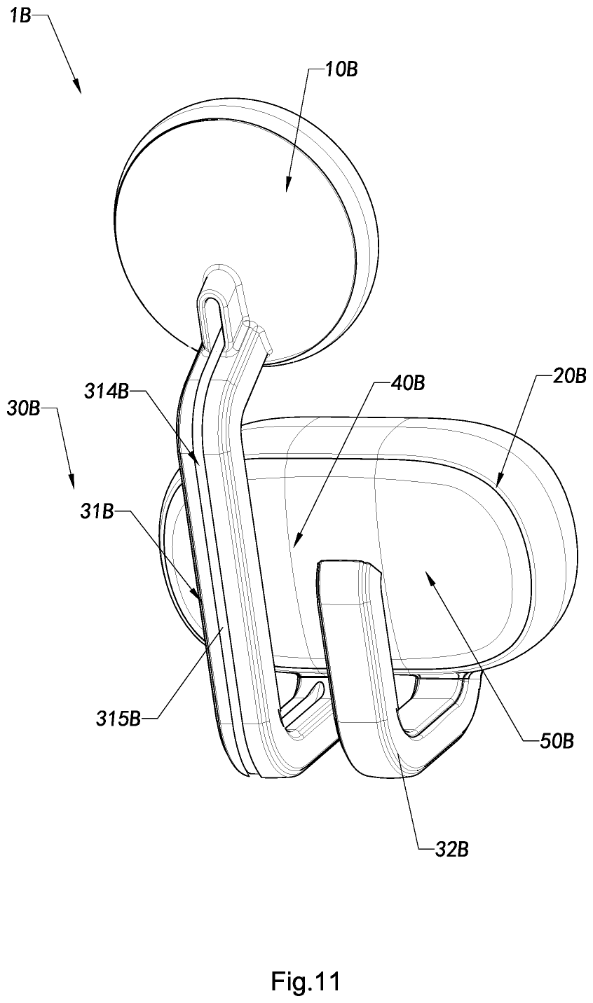

FIG. 11 of the drawings illustrates an ear-hanging headphone 1B according to a third preferred embodiment of the present invention. In this preferred embodiment, the ear-hanging headphone 1B is an alternative mode of the first preferred embodiment described above. Compared to the first preferred embodiment described above, in this embodiment, the connecting assembly 30B has been changed.

In this embodiment, the cavum conchae wearing portion 10B, the ear-hanging fixing assembly 20B, the fixing area 40B, and the control assembly 50B are similar to those in the above embodiment, so there is no need to further describe in details on this in this embodiment.

Specifically, FIG. 11 is a perspective view illustrating an overall structure of the ear-hanging headphone 1B according to the third preferred embodiment of the present invention. In this embodiment, the connecting assembly 30B comprises a first connecting portion 31B and a second connecting portion 32B. The two ends of the first connecting portion 31B are respectively connected to the cavum conchae wearing portion 10B and the ear-hanging fixing assembly 20B, and the lower end of the second connecting portion 32B is connected to the ear-hanging fixing assembly 20B. That is to say, the length of the first connecting portion 31B is greater than the length of the second connecting portion 32B, and the lower part of the first connecting portion 31B has the same structural form as the second connecting portion 32B.

Furthermore, the first connecting portion 31B has a connecting groove 314B, which is extended along an outer surface of the first connecting portion 31B. In other words, the connecting groove 314B is indented and distributed along the outer surface of the first connecting portion 31B. The wires 315B of the ear-hanging headphone 1B are suitable for being installed inside the connecting groove 314B, and after being installed inside the connecting groove 314B, the wires 315B are exposed to the outside, increasing the aesthetics of the ear-hanging headphone 1B. Additionally, users can choose the color and style of the wires 315B according to their preferences, enhancing the personalization of the ear-hanging headphone 1B.

In other embodiments, the wires can also be routed from the inside of the connecting assembly 30B. However, this is not a limitation of the present invention. Furthermore, the shape and size of the connecting groove 314B can also be set according to the user's needs. It should be understood by those skilled in the art that the shape and size of the connecting groove 314B are not limitations of the present invention. In other words, the outer side of the connecting groove 314B can be equipped with a light strip in the connecting groove 314B. The light strip is set to be transparent and forms the light strip after being illuminated by a light element, increasing the coolness of the ear-hanging headphone 1B and enhancing their aesthetics.

The ear-hanging headphone 1A further comprise a decorative unit 60A, and the decorative unit 60A is adapted to be set on at least a portion of the surface of the cavum conchae wearing portion 10, the ear-hanging fixing assembly 20, and the connecting assembly 30. The decorative unit 60A can be decorated by inlaying diamonds, patterns, carvings, etc., or by a detachable connection method, so that the ear-hanging headphone 1A have a decorative effect and improve the aesthetics of the ear-hanging headphone.

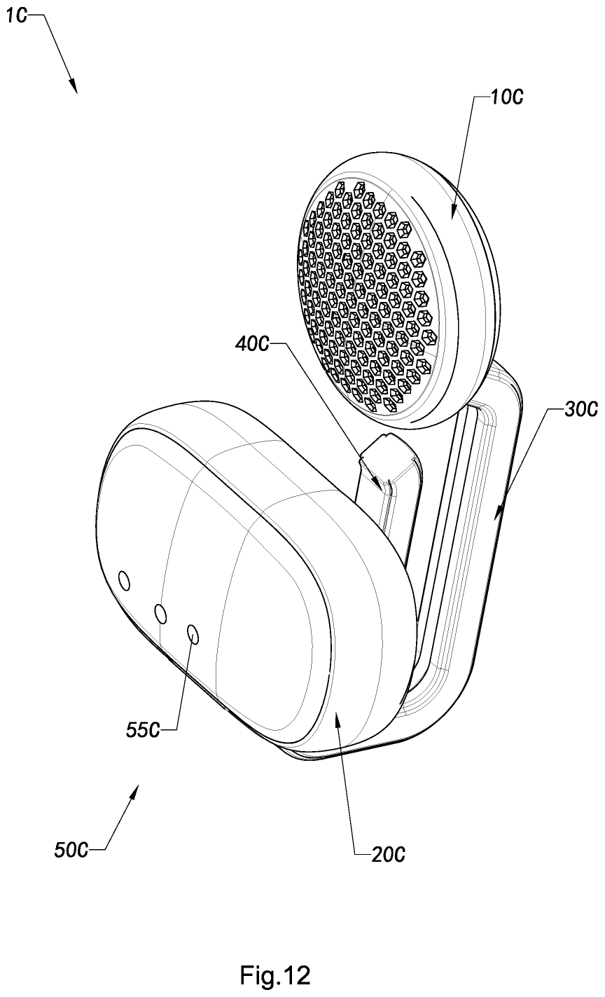

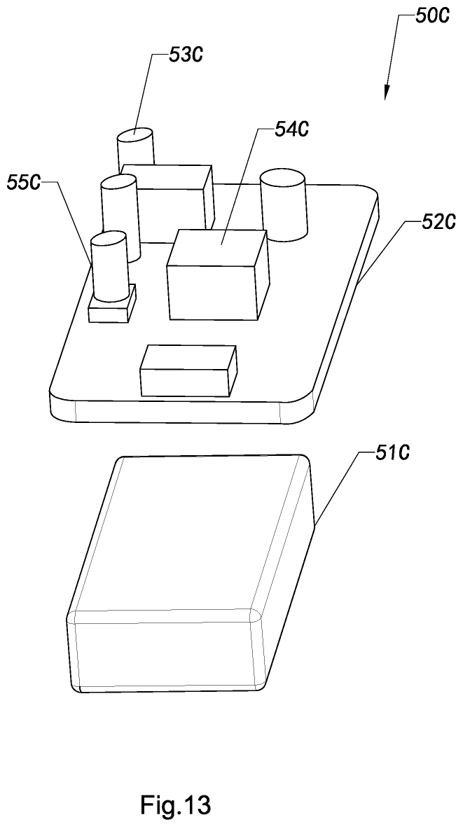

FIGS. 12 and 13 of the drawings illustrate an ear-hanging headphone 1C according a fourth preferred embodiment of the present invention, which provides. In this preferred embodiment, the ear-hanging headphone 1C is a modified alternative mode of the first preferred embodiment described above. Compared with the first preferred embodiment described above, in this embodiment, the connecting component control assembly 50C has been changed.

In this embodiment, the cavum conchae wearing portion 10C, the ear-hanging fixing assembly 20C, the connecting assembly 30C, and the fixing area 40C are all similar to those in the above embodiment, so they will not be described again in this embodiment.

FIG. 12 is a perspective view illustrating an overall structure of the ear-hanging headphone 1C according to the fourth preferred embodiment of the present invention. Specifically, in this embodiment, the ear-hanging fixing assembly 20C comprises the ear-hanging fixing assembly 20C, the control assembly 50C which comprises the earphone power supply 51C, the control circuit board 52C, at least one adjustment button 53C, and a smart communication module 54C. The earphone power supply 51C and the control circuit board 52C are both received within the ear-hanging fixing assembly 20C, and the adjustment button 53C is set on the surface of the ear-hanging fixing assembly 20C for convenient touch and press by the user. The smart communication module 54C is set within the ear-hanging fixing assembly 20C to electrically connect to the control circuit board 52C, and can be used in conjunction with smart homes, smart calls, smart driving, etc., for improving the convenience of user's life. The earphone power supply 51C, the control circuit board 52C, the adjustment button 53C, and the smart communication module 54C are electrically connected to each other.

FIG. 12 is a perspective view illustrating the control assembly 50C of the ear-hanging headphone 1C according to the fourth preferred embodiment of the present invention. More specifically, the control assembly 50C further comprises a hearing aid module 55C, which is disposed the ear-hanging fixing assembly 20C. A hearing aid module 55C is electrically connected to the control circuit board 52C and includes structures such as a microphone, an amplifier, and a receiver. The microphone is used to collect sound and convert it into electrical waves, the amplifier is used to increase the intensity of the electrical waves, and the receiver is used to convert the electrical energy back into sound waves. In this embodiment, the ear-hanging headphone 1C has both headphone functionality and hearing aid functionality. Specifically, when the ear-hanging headphone 1C is used in normal situations, the hearing aid functionality can be used, which is convenient for users with poor hearing, such as some elderly people. When a call comes in, the ear-hanging headphone 1C can be connected to a mobile phone via Bluetooth, and at this time, the ear-hanging headphone 1C switches to headphone functionality. Based on this, the ear-hanging headphone 1C is equipped with the hearing aid module 55C, avoiding the inconvenience of the replacing and the switch of the wearing of the conventional headphone and the hearing-aid device.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. An ear-hanging headphone, comprising:
a cavum conchae wearing portion for being placed in a user's cavum conchae and biasing against the user's antitragus;
an ear-hanging fixing assembly for fitting against a back side of the user's ear root; and
a connecting assembly, wherein two ends of said connecting assembly are respectively connected to said cavum conchae wearing portion and said ear-hanging fixing assembly to form a fixing area for holding the user's earlobe.

2. The ear-hanging headphone according to claim 1, wherein said cavum conchae wearing portion comprises a main body portion, a cover portion, and a speaker, wherein said cover portion is mounted on said main body portion, and said speaker is enclosed by said main body portion and said cover portion.

3. The ear-hanging headphone according to claim 2, wherein said cover portion has a plurality of holes penetrating said cover portion.

4. The ear-hanging headphone according to claim 2, wherein said ear-hanging fixing assembly comprises a fixing portion, an outer shell, and an inner shell, wherein said outer shell and said inner shell are respectively mounted two sides of said fixing portion to define an installation space.

5. The ear-hanging headphone according to claim 4, further comprising a control assembly comprising a headphone power supply and a control circuit board, wherein said headphone power supply and said control circuit board are both disposed in said ear-hanging fixing assembly.

6. The ear-hanging headphone according to claim 4, further comprising a smart communication module which is disposed in said ear-hanging fixing assembly, wherein said smart communication module is electrically connected to said control circuit board.

7. The ear-hanging headphone according to claim 1, wherein said connecting assembly comprises a first connecting portion, wherein two ends of said first connecting portion are respectively connected to said cavum conchae wearing portion and said ear-hanging fixing assembly.

8. The ear-hanging headphone according to claim 7, further comprising a second connecting portion which is spacedly apart from said first connecting portion, wherein a lower end of said second connecting portion is mounted to said ear-hanging fixing assembly.

9. The ear-hanging headphone according to claim 8, wherein said first connecting portion comprises an extending element, an upper extension portion, and a lower extension portion, wherein said upper extension portion and said lower extension portion are respectively integrally connected to an upper end and an lower end of said extending element, respectively, so as to be connected said cavum conchae wearing portion and said ear-hanging fixing assembly.

10. The ear-hanging headphone according to claim 8, wherein said connecting assembly comprises a first connecting portion and a second connecting portion, wherein said first connecting portion and said second connecting portion are interconnected to form an integral structure.

11. The ear-hanging headphone according to claim 1, wherein said first connecting portion comprises an upper fixing portion and an upper bending portion, and said second connecting portion comprises a lower fixing portion and a lower bending portion, wherein said upper fixing portion is connected to said cavum conchae wearing portion, said upper bending portion and said lower bending portion are interconnected, and said lower fixing portion is connected to said ear-hanging fixing assembly.

12. The ear-hanging headphone according to claim 1, further comprising a decorative unit, which is provided on at least a portion of said cavum conchae wearing portion, said ear-hanging fixing assembly, and said connecting assembly.

13. The ear-hanging headphone according to claim 1, wherein said connecting assembly comprises wires and has a connecting groove indented along one of outer side and inner side of said connecting assembly, wherein said wires are disposed in said connecting groove.

14. The ear-hanging headphone according to claim 1, wherein said control assembly further comprises a hearing aid module which is provided in said ear-hanging fixing assembly, wherein said hearing aid module is electrically connected to said control circuit board.

15. The ear-hanging headphone according to claim 1, wherein when said ear-hanging headphone is worn on the user, a lower portion of said cavum conchae wearing portion is biasing against the user's antitragus, wherein said ear-hanging fixing assembly fits against the back side of the user's earlobe, wherein an inner side edge of said ear-hanging fixing assembly is biasing against the back side of the user's ear root for positioning said ear-hanging headphone.

16. The ear-hanging headphone according to claim 15, wherein when said ear-hanging headphone is worn on the user, said connecting assembly is inclinedly extended between said cavum conchae wearing portion and said ear-hanging fixing assembly.

17. The ear-hanging headphone according to claim 2, wherein a material of said main body portion of said cavum conchae wearing portion, said ear-hanging fixing assembly, and said connecting assembly is one of copper, silver, stainless steel, precious metal, ABS material, PP material, PC material, rubber, and silicone material.
